(19) United States
(12) Patent Application Publication
(10) Pub. No.: US 2022/0398485 A1
(43) Pub. Date: Dec. 15, 2022

(54) PREVENTING DATA VULNERABILITIES DURING MODEL TRAINING

(71) Applicant: VERIZON PATENT AND LICENSING INC., Basking Ridge, NJ (US)

(72) Inventor: Subham BISWAS, Thane (IN)

(21) Appl. No.: 17/342,588

(22) Filed: Jun. 9, 2021

(51) Int. Cl. G06N 20/00; G06K 9/62

(52) U.S. Cl. CPC G06N 20/00; G06K 9/6255; G06K 9/6256; G06K 9/6268

(57) ABSTRACT

Disclosed are embodiments for preventing training data vulnerabilities in training data. In one embodiment, a method comprises receiving a first and second set of importance features for a first and second label output by a machine learning (ML) model; generating a first feature dictionary based on the first set of importance features and a second feature dictionary based on the second set of importance features; identifying a subset of labeled examples in a training dataset used to train the ML model based on the first feature dictionary and second feature dictionary; modifying the subset of labeled examples based on the first feature dictionary and second feature dictionary, the modifying generating a modified training data set; and retraining the ML model using the modified training data set.

### BACKGROUND INFORMATION

Certain machine learning (ML) models are trained using labeled training data. During training, ML models learn weights and other parameters based on the labeled training data. Thus, when training data is mislabeled, the ML model parameters can be inaccurate.

### BRIEF DESCRIPTION OF THE DRAWINGS

FIG. 1 is a block diagram illustrating a system for preventing data vulnerabilities during the training of machine learning models according to some example embodiments.

FIG. 2 is a flow diagram illustrating a method for preventing data vulnerabilities during the training of machine learning models according to some example embodiments.

FIG. 3 is a flow diagram illustrating a method for generating a feature dictionary according to some example embodiments.

FIG. 4 is a flow diagram illustrating a method for updating a training data set according to some example embodiments.

FIG. 5 is a block diagram illustrating a computing device showing an example of a client or server device used in the various embodiments.

### DETAILED DESCRIPTION OF EXAMPLE EMBODIMENTS

The disclosed embodiments describe methods, devices, and computer-readable media for preventing data vulnerabilities.

The disclosed embodiments initially train a model using a set of automatically generated training examples (e.g., trained using regular expressions or other rules-based techniques). The resulting model is analyzed to identify importance features on a per-class basis that the model uses in classifying test data. These importance features are then used to define a feature dictionary for each class predicted by the model. Using these dictionaries, the disclosed embodiments can then re-analyze the training data to identify training examples that were improperly labeled by the rules-based labeling. For example, the disclosed embodiments can change a label based on the correspondence between example features and the importance features for the assigned label. As another example, the disclosed embodiments can remove a training data example from training completely.

The disclosed embodiments improve the overall performance of a model by iteratively improving the underlying training data. That is, the model can automatically detect training examples that were improperly labeled or are inappropriate for training. By re-training the model after this identification/modification, the resulting model can provide higher quality predictions for future data without requiring manual editing of training data sets. Further, by automating the training data analysis, larger training data sets can be used to train the model, resulting in better tuning of model parameters.

The disclosed embodiments receive a first and second set of importance features associated with a first and second label, respectively, and identify first and second label features, respectively, used by a machine learning (ML) model to classify data with the first label, and the second set of importance features associated with a second label and identify second features used by the ML model to classify data with the second label. In one embodiment, the list of features can be determined by analyzing the features of each example classified by the ML model and selecting a top feature (i.e., the feature most contributing to the classification) or the top n features (where n is less than the total number of features in an example) for each example. In some embodiments, the disclosed embodiments can select the two top features per example. The disclosed embodiments generate a first feature dictionary based on the first set of importance features and a second feature dictionary based on the second set of importance features. The disclosed embodiments identify a subset of labeled examples in a training dataset used to train the ML model based on the first feature dictionary and second feature dictionary. The disclosed embodiments modify the subset of labeled examples based on the first feature dictionary and second feature dictionary, the modifying generating a modified training data set. The disclosed embodiments then retrain the ML model using the modified training data set.

In some embodiments, each importance filter is associated with a corresponding confidence value and the disclosed embodiments filter the first set of importance features and the second set of importance features, the filtering comprising removing an importance feature having a confidence value below a pre-configured threshold.

In some embodiments, generating a feature dictionary for a respective label and a respective set of importance features includes identifying a set of unique importance features for the respective label, calculating a total number of occurrences for each of the unique importance features in the respective set of importance features, ordering the set of unique importance features by the total number of occurrences to generate an ordered set of unique importance features, and storing the ordered set of unique importance features as the feature dictionary, the storing comprising associating each unique importance feature with a corresponding total number of occurrences.

In some embodiments, the disclosed embodiments further include generating a common feature dictionary that includes a set of importance features present in both the first feature dictionary and the second feature dictionary. In some embodiments, the identifying a subset of labeled examples includes filtering the labeled examples using the common feature dictionary.

In some embodiments, identifying a subset of labeled examples includes determining, for a respective labeled example, whether a number of importance features in the respective labeled example appearing in a corresponding feature dictionary exceeds a pre-configured threshold. In some embodiments, modifying the subset of labeled examples includes one or more of altering a label of a respective labeled example or removing the respective labeled example from the subset of labeled examples.

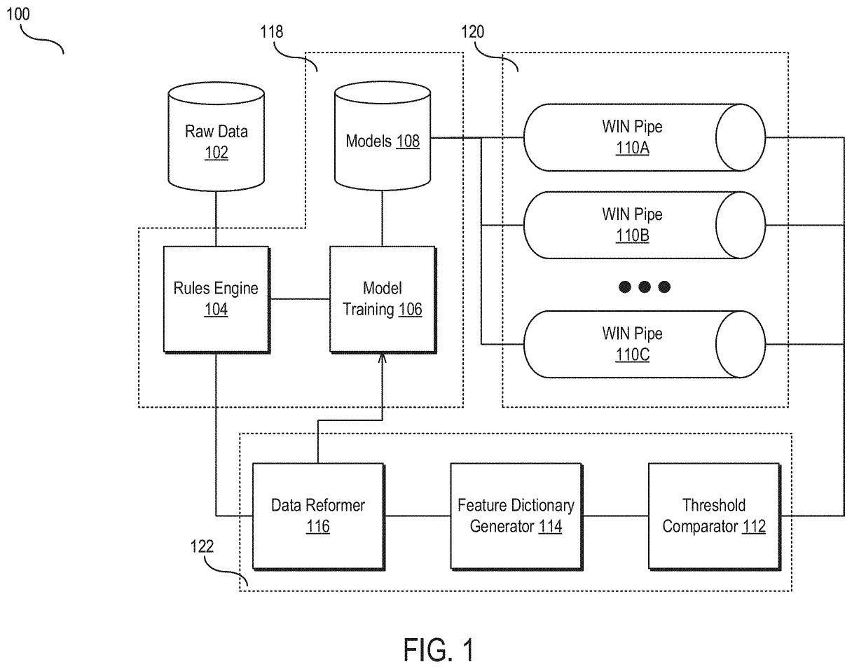

FIG. 1 is a block diagram illustrating a system 100 for preventing data vulnerabilities during the training of machine learning models according to some example embodiments.

In an embodiment, system 100 includes a raw data storage medium 102, a model training system 118, a feature importance notation system 120, and a training data reformer engine 122. In an embodiment, raw data storage medium 102 can comprise a filesystem (distributed of local), database, or another storage device capable of storing data utilized as training examples for machine learning. Although the following description focuses on text data, raw data storage medium 102 may store any type of data (e.g., image data, audio data, video data, structured data, etc.), and the disclosure is not limited solely to text data processing. In general, and as is discussed, any sequence data (e.g., image, audio, video) can be analyzed using the disclosed embodiments provided that importance features used by a model can be identified for the underlying data type.

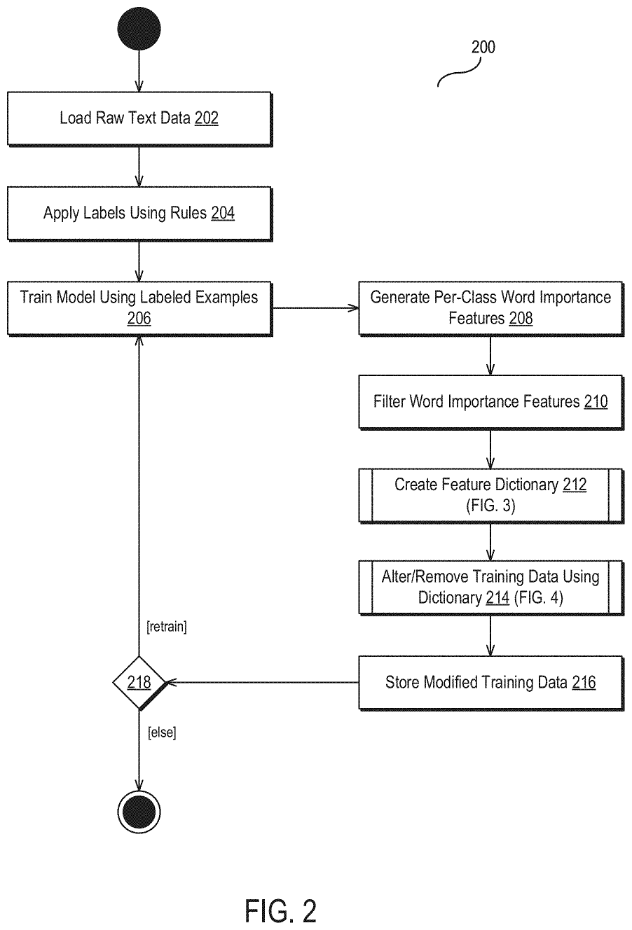

System 100 feeds raw data from raw data storage medium 102 into a rules engine 104, which generates labels for the raw data. In an embodiment, rules engine 104 can comprise a software and/or hardware device that processes raw data and applies labels to the raw data according to one or more rules. In one embodiment, rules engine 104 can comprise a software application that matches the raw data to a plurality of regular expressions to determine labels. In such an embodiment, each regular expression may be associated with a label, and when raw text data features (e.g., a paragraph, sentence, etc.) match the regular expression, the rules engine 104 applies the corresponding label to the features and outputs a labeled example to model training unit 106. For non-text data, general rules can be used in lieu of regular expressions, and the disclosed embodiments are not limited to text-based rules. For example, an average color intensity of images can be used to classify training images based on emotion (e.g., happy, sad, etc.). Other techniques, discussed in the description of step 204 of FIG. 2, may also be used.

Model training unit 106 receives labeled examples from the rules engine 104 and trains an ML model using the labeled examples. The disclosed embodiments place no limitation on the type of ML model that may be used. Indeed, any ML model that applies labels (i.e., classifies) data can be trained by model training unit 106. Examples of such models include naïve Bayes models, linear regression models, support vector machine (SVM) models, or neural networks (including deep neural networks) such as, recurrent neural network (RNN) models, long/short-term memory (LSTM) models, convolutional neural network (CNN) models, etc.

In an embodiment, model training unit 106 writes the learned parameters to a model storage device 108. In an embodiment, model storage device 108 can comprise any storage medium capable of storing data describing the trained model. In some embodiments, model storage device 108 can store the weights, parameters, and other learned data points describing the model for future use.

In an embodiment, a plurality of word importance notation (WIN) pipes 110A, 110B, 110C are communicatively coupled to the model storage device 108. In an embodiment, the number of WIN pipes 110A, 110B, 110C is equal to the number of unique labels or classifications the model stored in the model storage device 108 is configured to apply. For example, a binary model may only require two WIN pipes, while a sentiment classification model may comprise many WIN pipes. Although word importance is used as an example, WIN pipes 110A, 110B, 110C may comprise general feature importance pipes. WIN pipes 110A, 110B, 110C may comprise dedicated models that, given a model and an output, labeled example, can identify the “important” features (e.g., words) that influenced the model's classification. In an embodiment, the WIN pipes 110A, 110B, 110C additionally assign a confidence level to each importance feature. WIN pipes 110A, 110B, 110C can comprise Local Interpretable Model-agnostic Explanation (LIME) models, Shapley Additive exPlanations (SHAP) models, or similar models. Details regarding the operation of WIN pipes 110A, 110B, 110C are provided in the description of step 208 of FIG. 2. Although WIN pipes 110A, 110B, 110C are described in the foregoing examples, any other model capable of identifying importance features can be used in lieu of WIN pipes 110A, 110B, 110C depending on the type of data analyzed.

In an embodiment, WIN pipes 110A, 110B, 110C output importance features to threshold comparator 112. In an embodiment, threshold comparator 112 filters the importance features based on an associated confidence. In an embodiment, the threshold comparator 112 determines if the confidence of a given importance feature output by WIN pipes 110A, 110B, 110C exceeds a filtering cutoff. If not, the threshold comparator 112 discards the importance feature. Alternatively, if the threshold comparator 112 determines that the confidence level associated with an importance feature exceeds the filtering cutoff, the threshold comparator 112 forwards the importance feature to the feature dictionary generator 114. Details of the threshold comparator 112 are described in the description of step 210 of FIG. 2.

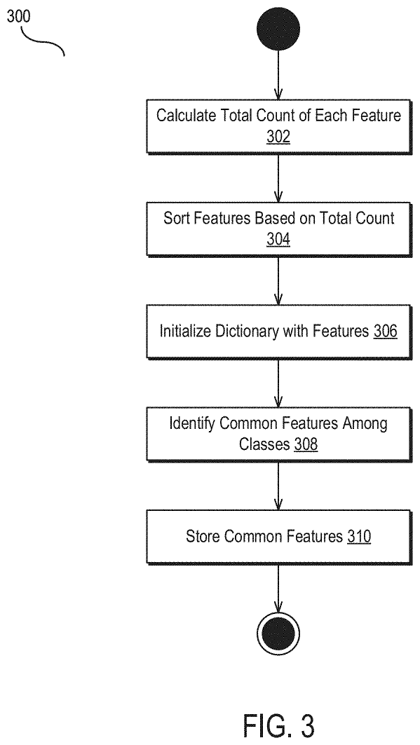

The feature dictionary generator 114 receives the importance features (e.g., words) and associated confidences and constructs a feature dictionary for each class or label. For example, the feature dictionary generator 114 generates a positive dictionary for a “positive” label and a negative dictionary for a “negative” label in a binary sentiment analysis model. In some embodiments, the feature dictionary generator 114 can further generate a common feature dictionary that includes all importance features that appear in two or more corresponding feature dictionaries. Details of the operation of the feature dictionary generator 114 are provided in step 212 of FIG. 2 and the entirety of FIG. 3.

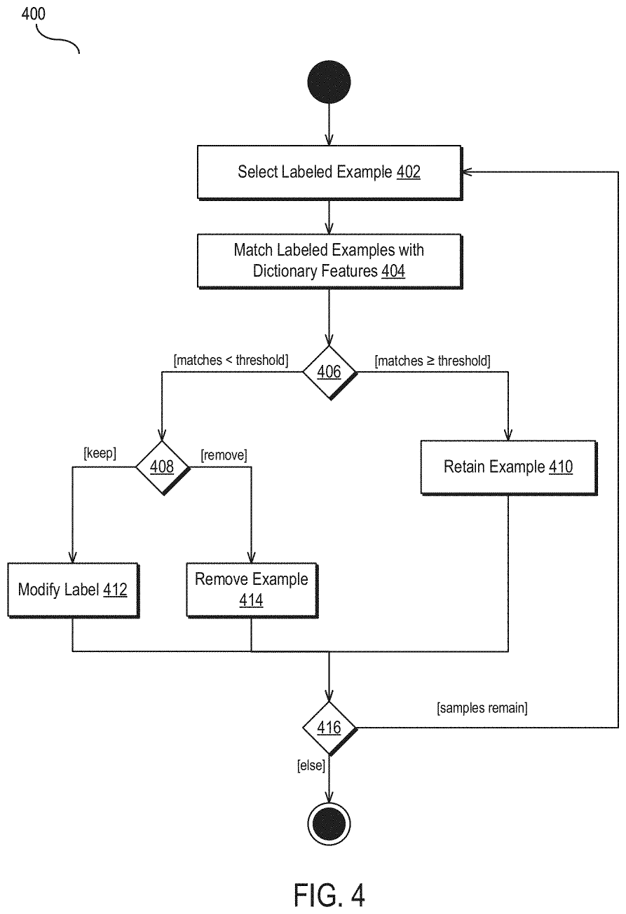

In an embodiment, the data reformer 116 receives the labeled examples from rules engine 104 and the feature dictionaries from the feature dictionary generator 114. The data reformer 116 compares some or all of the labeled examples to the feature dictionaries and changes labels or removes examples entirely based on the comparison. In an embodiment, the data reformer 116 can transmit the modified labeled examples to the model training unit 106 for retraining. Details of the operation of the data reformer 116 are provided in step 214 of FIG. 2 and the entirety of FIG. 4.

FIG. 2 is a flow diagram illustrating a method for preventing data vulnerabilities during the training of machine learning models according to some example embodiments.

In step 202, method 200 can comprise loading raw data (e.g., text data). In an embodiment, raw data can comprise any text data, and no limit is placed on the content of the text data. In an embodiment, method 200 can load the raw text data from a file, database, big data storage array, or any other device or software that can store text data. As discussed above, in some embodiments, the raw data can comprise non-text data.

In one embodiment, method 200 comprises converting the raw data to a set of unlabeled examples. As used herein, an example refers to a set of features (e.g., words or portion of text). In one embodiment, method 200 can split a paragraph (or document) of text into individual sentences, and each sentence comprises features of an example. Other text parsing techniques can be used. In general, any techniques will generate one or more characters.

In step 204, method 200 can comprise applying labels to the unlabeled examples using a set of rules.

In one embodiment, the rules can comprise a set of conditions to check for each example and one or more labels to apply to an example if the raw data matches at least one condition. In one embodiment, the rules can comprise one or more regular expressions to determine how to add a label to an example. As an example in the context of text data, a first regular expression (/good/) and a second regular expression (/bad/) can be applied to a first example (“This movie was quite good!”) and a second example (“I thought the acting was very bad.”). The first unlabeled example matches the first regular expression and not the second and thus can be labeled as good, whereas the second unlabeled example matches the second regular expression and not the first and thus can be labeled as bad. As indicated, each regular expression can be manually assigned to a label, thus allowing for rapid (but potentially inaccurate labeling) of unlabeled examples. For example, a regular expression of /good/ matches the sub-string “not very good” and thus may incorrectly label an example as a positive example despite the presence of the negative term “not very.” Although regular expressions are used as examples, other techniques may be used. For example, the unlabeled examples can be converted to vectors (e.g., using word2vec or similar word embedding models), and the resulting vectors may be clustered using an unsupervised clustering algorithm (e.g., k-means) to generate a plurality of clusters. Next, a term frequency-inverse document frequency (tf-idf) routine may be applied to each cluster to surface the most common terms (excluding stop words) and using some or all of the most common terms as sentiment labels. In an embodiment, the raw data and accompanying labels generated in step 204 are referred to as labeled examples.

In step 206, method 200 can comprise training a model using the labeled examples. In an embodiment, the model may comprise a model that predicts a label for a given unlabeled example. Various classifier models may be used, and the disclosure is not limited to a specific model. For example, the model trained in step 206 can comprise a support vector machine (SVM), naïve Bayes model, linear regression model, or a neural network (including deep neural networks) such as a recurrent neural network (RNN), long/short-term memory (LSTM), convolutional neural network (CNN), etc. As will be discussed, the specific model trained in step 206 is not limiting, and the approaches described herein can be applied to any model.

In step 208, method 200 can comprise generating per-class importance features for the model.

In one embodiment, method 200 may separate the labeled examples generated in step 206 into categories based on the labels. Each category can thus include a plurality of examples, all of which can share the same label. In one embodiment, method 200 supplies some or all of the examples in a given category to a word importance notation (WIN) model, which determines which words influenced the model to generate the label. Although the embodiments describe per-class importance features in the context of text data, other forms of data may be considered when determining importance features of a class label.

In general, method 200 will generate, for example, a list of features that caused the model to assign the label to the example. In the following examples and embodiments, features that cause a model to assign a given label can be referred to as the importance features for a given label. In general, importance features are those features that, when present in an example, will cause a model to assign a given label. In one embodiment, the list of features can be determined by analyzing the features of each example classified by the ML model and selecting a top feature (i.e., the feature most contributing to the classification) or the top n features (where n is less than the total number of features in an example) for each example. In some embodiments, the disclosed embodiments can select the two top features per example.

For example, the text “The food was great, we loved it! Dinner was a huge success!” may be classified with a “positive” label. When applying a WIN model to this text, the model may output the list (great, loved, success) as the top terms that influenced the model's classification. Similarly, the text “This movie was a flop (really bad). I've never seen a more boring movie in my life.” can be classified with a “negative” label. When applying a WIN model to this text, the model may output the list (bad, boring, flop) as the top terms that influenced the model's classification.

In some embodiments, the WIN models can additionally generate a confidence level for each word identified as important. In an embodiment, the confidence level can comprise a floating-point value representing the confidence of the identification with a higher score representing a higher confidence that the word did, in fact, contribute to the labeling. For example, the words (great, loved, success) discussed above can be assigned confidence levels of (0.8, 0.6, 0.2) indicating that it is more likely that the word “great” contributed more to the labeling than the words “loved” and “success”.

In an embodiment, each label is assigned a separate WIN model, and the corresponding WIN model may be trained using properly labeled examples. Various feature importance models can be used to implement the WIN models, including, but not limited to, LIME models or SHAP models. In general, however, any model that can predict or estimate the importance of features in influencing a model's output can be used.

As discussed at the conclusion of step 208, method 200 obtains, for each labeled example, a label, a feature, and a set of importance features (e.g., words) and corresponding confidence values. For example:

```
  [
    {
      label: ‘positive’,
        features: ‘The food was great, we loved it! Dinner
                                  was a huge success!’,
        important_features: [(‘great’, 0.82), (‘loved’, 0.69),
                                          (‘success’, 0.25)],
    },
          ...
    {
        label: ‘negative,
        features: ‘This movie was a flop (really bad). I’ve never
                        seen a more boring movie in my life.’,
        important_features: [(‘bad’, 0.90), (‘boring’, 0.71),
                                          (‘flop’, 0.25)],
    }
]
                            EXAMPLE 1
```

In some embodiments, the entire data structure in Example 1 can be used in step 210. However, in other embodiments, only the importance features field may be used.

In step 210, method 200 can comprise filtering the importance features.

In an embodiment, step 210 can be performed per-label (and thus, per importance model). In one embodiment, method 200 analyzes each set of importance features and removes those features having a confidence level below a pre-configured threshold (e.g., 0.3). Thus, when processing Example 1 with a confidence threshold of 0.3, method 200 can generate a filtered set of examples as follows:

```
  [
    {
        label: ‘positive’,
        features: ‘The food was great, we loved it! Dinner was
                        a huge success!’,
        important_features: [(‘great’, 0.82), (‘loved’, 0.69)],
    },
          ...
    {
        label: ‘negative.
        features: ‘This movie was a flop (really bad). I’ve
                        never seen a more boring movie in my life.’,
        important_features: [(‘bad’, 0.90), (‘boring’, 0.71)],
    }
]
                                                      EXAMPLE 2
```

Here, the features of “success” and “flop” were removed as the confidence levels were below the threshold. In an embodiment, the confidence threshold can be adjusted as needed.

In step 212, method 200 can comprise creating a feature dictionary for each label.

After processing step 210, method 200 provides an array of importance feature sets (and confidence levels) for each class output by the ML model. In an embodiment, a feature dictionary comprises a mapping of features (e.g., words) to a count of the total occurrences of the features. Thus, the dictionary can comprise a plurality of key-value pairs wherein the key comprises a feature (e.g., word) to a count of the number of times that feature is identified as important. In some embodiments, the key-value pairs are ordered, in descending order, by the count. As described next, FIG. 3 provides further detail on the creation of a feature dictionary, and the disclosure is not repeated herein.

In step 214, method 200 can comprise altering and/or removing training data using the feature dictionary. In an embodiment, method 200 analyzes the labeled examples and determines whether any of the labeled examples need to be changed based on the feature dictionary. Details of this step are provided in the embodiments of FIG. 4, which are not repeated herein. In brief, altering the training data can comprise changing a label of a labeled example used for training in step 206. Similarly, removing training data can comprise completely removing a labeled example during training in step 206.

In step 216, method 200 can comprise storing the modified training data. In one embodiment, method 200 can store the modified training data as a second training data set (thus, retaining the original training data used in step 206). In another embodiment, method 200 can replace the original training data used in step 206 with the modified training data.

In step 218, method 200 can comprise determining whether to retrain the model in step 206. If method 200 determines that retraining is needed, method 200 executes step 206 again. In some embodiments, method 200 may only execute step 206 during retraining and end. However, in some embodiments, method 200 can further execute steps 208, 210, 212, 214, and 216 during each retraining until determining not to retrain the model. As illustrated, upon determining not to retrain the model, method 200 ends.

FIG. 3 is a flow diagram illustrating a method for generating a feature dictionary according to some example embodiments.

In step 302, method 300 can comprise calculating a total count for each importance feature in a set of labeled examples.

As described in FIG. 2, method 300 may receive a set of labeled examples, where each labeled example includes a set of importance features (e.g., words, image pixel sequences, etc.) and a corresponding confidence value. In step 302, method 300 extracts a set of unique importance features in the labeled examples (i.e., a set of features from a list of potentially duplicated features). Next, method 300 can compute the total number of times each feature occurs across all labeled examples.

In step 304, method 300 can sort the set of features by the total count. In some embodiments, method 300 can sort the set of features by total count in descending order.

In step 306, method 300 can initialize the dictionary with the set of features. In one embodiment, method 300 stores the set of features to persistent storage. In other embodiments, method 300 can store the set of features in memory as the feature dictionary. The following example illustrates steps 302, 304, 306 for a sample set of importance features associated with a “positive” label.

In this example, the following importance features may be provided:

```
[
  {important_features: [(‘great’, 0.82), (‘loved’, 0.69)]},
  {important_features: [(‘great’, 0.56), (‘nice’, 0.52)]},
  {important_features: [(‘great’, 0.76), (‘nice’, 0.52)]},
  {important_features: [(‘nice’, 0.67), ( ‘great, 0.48)]},
]
```

### Example 3

In response, method 300 can execute step 302 and identify the following set of unique features and associated counts:

TABLE 1

| Importance feature | Count |
|---|---|
| great | 4 |
| loved | 1 |
| nice | 3 |

Next, in step 304, method 300 sorts the feature-count pairs by the determined count:

TABLE 2

| Importance feature | Count |
|---|---|
| great | 4 |
| nice | 3 |
| loved | 1 |

Finally, in step 304, method 300 persists (or stores in memory) the ordered dictionary. In one embodiment, method 300 can store the above table in a serialized format: [(‘great’, 4), (‘nice’, 3), (‘loved’, 1)].

As discussed, method 300 performs steps 302, 304, and 306 for each type of label (e.g., class) output by the model in step 206. Thus, in an embodiment, method 300 generates multiple dictionaries, one per label output by the ML model. In some embodiments, method 300 may only store the features and not the count (as will be discussed).

In step 308, method 300 identifies the common features among classes. In some embodiments, steps 308 and 310 can be optional.

In the preceding steps, a dictionary can be created for each class or label. Since the dictionaries are created independently, two or more dictionaries may include overlapping features (e.g., words). In an embodiment, method 300 identifies pair wise overlaps among the dictionaries. In an embodiment with two dictionaries (e.g., for positive and negative labels), method 300 can compute a single overlapping dictionary of common features. However, in embodiments with more than two labels, method 300 will generate (k²−k)/2 lists of overlapping features for k labels. In some embodiments, method 300 can use simultaneous feature matching (SFM) to identify the lists of overlapping features among multiple dictionaries. In one embodiment, method 300 may compute pair wise overlaps but combine all overlapping features into a single common feature dictionary. In this embodiment, the common feature dictionary comprises a list of features that appear in at least two feature dictionaries.

In step 310, method 300 can store the identified common features in a manner similar to step 306. In one embodiment, method 300 stores the set of common features to persistent storage. In other embodiments, method 300 can store the set of common features in memory as the feature dictionary.

FIG. 4 is a flow diagram illustrating a method for updating a training data set according to some example embodiments.

As discussed previously, method 400 receives a feature dictionary and a set of labeled examples. Method 400 uses these datasets to modify the set of labeled examples to generate a modified training data set. As discussed in FIG. 2, this modified training data set can be used to retrain the ML model.

In the following description, two feature dictionaries will be used as non-limiting examples: one for positive sentiments and one for negative sentiments. A positive feature dictionary can include the following features:

```
[(‘great’, 458), (‘movie’, 265),
  (‘bad’, 186), (‘best’, 111),
  (‘love’, 75), (‘excellent’, 69),
  (‘worst’, 54),  (‘good’, 23)]
```

Similarly, a negative feature dictionary can include the following features:

```
[(‘bad’, 485), (‘movie’, 437),
  (‘worst’, 232), (‘waste’, 104),
  (‘terrible’, 84), (‘boring’, 71),
  (‘great’, 67), (‘awful’, 39)]
```

Both dictionaries can be generated using method 300 as described previously.

In step 402, method 400 selects a labeled example. In an embodiment, the labeled example can comprise an example and label used in step 206 of FIG. 2 to train the ML model.

In some embodiments, the dictionaries of common features can be used to filter the labeled examples prior to proceeding. As discussed in FIG. 3, method 300 can generate one or more dictionaries of features that are important to multiple labels of classes. For example, the features “movie,” “bad,” “great,” and “worst” appear in both dictionaries. Thus, these four features comprise a dictionary of common features. In one embodiment, these common features can be used to reduce the total amount of labeled examples processed using method 400. In one embodiment, method 400 can omit any labeled examples that do not include features in the common features dictionary. For example, the feature set (“best,” “love,” “excellent”) does not include any common features and can be excluded from further processing. In such an embodiment, the use of feature importance determination can provide reasonable certainty that a labeled example that only includes features associated with a single class was properly classified or, at a minimum, did not negatively influence the ML model. Thus, the use of common features enables massive filtering of labeled examples to only identify those potentially vulnerable examples.

In step 404, method 400 matches the labeled example to features in the feature dictionaries.

In one embodiment, method 400 can match each feature from the labeled example (e.g., word) with features in the dictionaries generated for each class. As part of this step, method 400 can remove any features (e.g., words) in the labeled examples that are not in the dictionaries. Such features can be considered as not influencing the model output and thus can be excluded from further processing.

As discussed above, some features can appear in a single dictionary (e.g., a single dictionary for a given label), while some features may appear in multiple dictionaries. Thus, in some embodiments, features in a labeled example can be classified based on the corresponding dictionary.

In step 406, method 400 determines if the number of matches in a feature dictionary associated with the label of the labeled example is above a threshold.

In one embodiment, method 400 determines the label for the selected label example and then determines if the number of features identified in step 404 that appear in the corresponding feature dictionary is greater than a preset threshold.

For example, the selected example in step 402 may comprise the phrase “This movie was great, the actors were excellent!” which includes the features “movie,” “great,” and “excellent.” The example may further be labeled as “positive” by the ML model. In step 404, method 400 determines that the three features all appear in the positive dictionary while only two features (“movie” and “great”) appear in the negative dictionary. If, for example, the preset threshold is set to two (2), method 400 can proceed to step 410 since the number of positive dictionary features is greater than the threshold.

As a counterexample, an example “The movie was terrible, a complete waste of time” was labeled as positive, method 400 can proceed to step 408. Specifically, method 400 will identify (in step 404) three features: “movie,” “terrible,” and “waste.” Based on the dictionaries, method 400 can determine that one feature appears in the positive dictionary while three appear in the negative dictionary. If the preset threshold remains two (2), method 400 determines that the number of positive dictionary features (1) is less than the threshold (2) and thus proceeds to step 408.

In step 410, when method 400 determines that the number of features for a labeled example that corresponds to the corresponding feature dictionary meets or exceeds a preset threshold, the labeled example is retained during any future retraining. Specifically, method 400 can determine that the labeled example was properly labeled.

If method 400 determines that the number of matches in a feature dictionary associated with the label of the labeled example is below a threshold, method 400 proceeds to step 408, where it determines whether to remove or alter the label for the associated example.

In some embodiments, the decision to alter or remove can comprise a static decision determined based on retraining accuracy improvements. That is, in some embodiments, the filtering cutoff (threshold) used in step 210 of FIG. 2 can be adjusted and either altering or removing can be toggled. The resulting accuracy of the model can then be analyzed to determine whether to use the selected filtering cutoff in step 210 and whether to use an altering or removing strategy in step 408.

The following table illustrates an example of the filtering cutoff and strategy settings and corresponding accuracies of training predictions:

TABLE 3

| Filtering | Accuracy | Accuracy | Accuracy |
|---|---|---|---|
| Cutoff | (Baseline) | (with Removal) | (with Alteration) |
| 0.02 | 74.40 | 76.70 | 79.30 |
| 0.03 | 74.40 | 77.50 | 79.80 |
| 0.04 | 74.40 | 80.20 | 80.70 |
| 0.05 | 74.40 | 77.50 | 79.35 |

In an embodiment, the above Table 3 can be obtained by changing the filtering cut off and alter/remove strategy preference and retraining and re-executing ML model tests. The accuracy can be determined by comparing a predicted label to an expected label. As illustrated, the baseline accuracy refers to the accuracy of the model obtained by training the model using the examples labeled using rules or regular expressions, whereas the accuracies with removal or alteration correspond to the accuracy of the model after retraining after modifying the training data. As illustrated, in the hypothetical results, by using a filtering cutoff of 0.04 (e.g., a minimum confidence level) and enabling altering of training data (step 412), the performance of the ML model can be improved most.

In other embodiments, the decision to alter or remove an example can be performed programmatically. Specifically, method 400 can determine if there is one or more other feature dictionaries that satisfy the threshold in step 406. For example, if a positive-labeled example does not meet the threshold when compared to the positive dictionary but satisfies the threshold when compared to a negative dictionary, method 400 may decide (in step 408) to alter the example's label. Conversely, if a positive example does not meet the threshold when compared to the positive dictionary and does not meet the threshold for any other dictionary, method 400 may determine (in step 408) to remove the example entirely.

In step 412, method 400 modifies a label for the example. In some embodiments, the ML model may predict two classes. Thus, in step 412, method 400 can change the label of the example to the other valid label (e.g., from negative to positive or vice versa).

In other embodiments, however, the ML model may generate more than two labels. In this scenario, method 400 must determine the best label to apply to the data. In this embodiment, method 400 can compare the features associated with the examples to each feature dictionary and identify one or more dictionaries having the highest number of matches. If method 400 identifies a single feature dictionary having the most features, method 400 can replace the label for the example with the label associated with that feature dictionary. However, in some scenarios, the number of overlapping features will be the same for multiple feature dictionaries. In this scenario, method 400 can utilize the frequencies associated with the overlapping features to break a tie. For example, if an example includes features (“great”, “movie”, “best”) and a first dictionary includes ((‘great’, 900), (‘movie’, 750), (best, '700)) while a second dictionary includes ((‘movie’, 700′), (‘best’, 400), (‘great’, 350)), method 400 can sum the frequencies of these overlapping dictionary features to obtain a value of 2,350 for the first dictionary and 1,450 for the second dictionary. Since the first dictionary's total count is higher than the second, method 400 can use the label for the first dictionary to modify the example's label. Other similar techniques can be used. In some embodiments, when method 400 cannot quantitatively choose between two or more dictionaries (e.g., all metrics are identical), method 400 can randomly select a feature dictionary and use the corresponding label as the new label. Alternatively, method 400 can proceed to remove the example entirely in step 414.

In step 414, method 400 removes the example from the training data. In this step, method 400 removes the example completely from the training data prior to retraining the ML model (steps 218, 206 of FIG. 2). As discussed, in some embodiments, method 400 may not modify the original training data but rather omit saving the removed example from a copy of the training data set.

In step 416, method 400 determines if all relevant examples have been analyzed. If not, method 400 restarts execution at step 402 for the remaining labeled examples. If so, method 400 ends and, as discussed in FIG. 2, may proceed to retrain the ML model using the modified training data.

The foregoing description primarily operates on text data (e.g., text-based examples). However, the disclosed embodiments are not limited only to text data and can be applied to various other types of data. Indeed, the disclosed embodiments can be applied to any sequence data wherein features are capable of being extracted (e.g., using LIME/SHAP explainability models) from the raw data and mapped to a dictionary on a per-class basis. For example, an image classification model (e.g., a convolutional neural network) can be analyzed to determine which sequences of pixels contributed to the classification of the image.

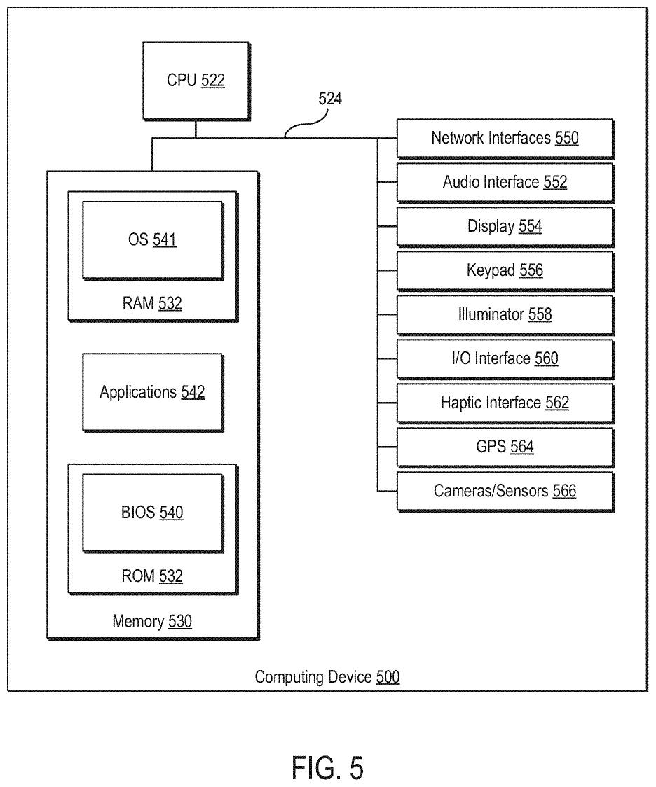

FIG. 5 is a block diagram illustrating a computing device showing an example of a client or server device used in the various embodiments.

The computing device 500 may include more or fewer components than those shown in FIG. 5, depending on the deployment or usage of the computing device 500. For example, a server computing device, such as a rack-mounted server, may not include an audio interface 552, display 554, keypad 556, illuminator 558, haptic interface 562, Global Positioning System receiver 564, or sensors 566 (e.g., camera, temperature sensor, etc.). Some devices may include additional components not shown, such as graphics processing unit (GPU) devices, cryptographic coprocessors, artificial intelligence (AI) accelerators, or other peripheral devices.

As shown in the figure, the computing device 500 includes a central processing unit (CPU) 822 in communication with a mass memory 530 via a bus 524. The computing device 500 also includes a network interface 550, an audio interface 552, a display 554, a keypad 556, an illuminator 558, an input/output interface 560, a haptic interface 562, a Global Positioning System receiver 564 and cameras or sensors 566 (e.g., optical, thermal, or electromagnetic sensors). Computing device 500 can include sensors 566. The positioning of the sensors 566 on the computing device 500 can change per computing device 500 model, per computing device 500 capabilities, and the like, or some combination thereof.

In some embodiments, the CPU 522 may comprise a general-purpose CPU. The CPU 522 may comprise a single-core or multiple-core CPU. The CPU 522 may comprise a system-on-a-chip (SoC) or a similar embedded system. In some embodiments, a GPU may be used in place of, or in combination with, a CPU 522. Mass memory 530 may comprise a dynamic random-access memory (DRAM) device, a static random-access memory device (SRAM), or a Flash (e.g., NAND Flash) memory device. In some embodiments, mass memory 530 may comprise a combination of such memory types. In one embodiment, the bus 524 may comprise a Peripheral Component Interconnect Express (PCIe) bus. In some embodiments, the bus 524 may comprise multiple busses instead of a single bus.

Mass memory 530 illustrates another example of computer storage media for the storage of information such as computer-readable instructions, data structures, program modules, or other data. Mass memory 530 stores a basic input/output system, BIOS 540, for controlling the low-level operation of the computing device 500. The mass memory also stores an operating system 541) for controlling the operation of the computing device 500.

Applications 542 may include computer-executable instructions which, when executed by the computing device 500, perform any of the methods (or portions of the methods) described previously in the description of the preceding figures. In some embodiments, the software or programs implementing the method embodiments can be read from a hard disk drive (not illustrated) and temporarily stored in RAM 532 by CPU 522. CPU 522 may then read the software or data from RAM 532, process them, and store them to RAM 532 again.

The computing device 500 may optionally communicate with a base station (not shown) or directly with another computing device. Network interface 550 is sometimes known as a transceiver, transceiving device, or network interface card (NIC).

The audio interface 552 produces and receives audio signals such as the sound of a human voice. For example, the audio interface 552 may be coupled to a speaker and microphone (not shown) to enable telecommunication with others or generate an audio acknowledgment for some action. Display 554 may be a liquid crystal display (LCD), gas plasma, light-emitting diode (LED), or any other type of display used with a computing device. Display 554 may also include a touch-sensitive screen arranged to receive input from an object such as a stylus or a digit from a human hand.

Keypad 556 may comprise any input device arranged to receive input from a user. Illuminator 558 may provide a status indication or provide light.

The computing device 500 also comprises an input/output interface 560 for communicating with external devices, using communication technologies, such as USB, infrared, Bluetooth™, or the like. The haptic interface 562 provides tactile feedback to a user of the client device.

The Global Positioning System receiver 564 can determine the physical coordinates of the computing device 500 on the surface of the Earth, which typically outputs a location as latitude and longitude values. Global Positioning System receiver 564 can also employ other geo-positioning mechanisms, including, but not limited to, triangulation, assisted GPS (AGPS), E-OTD, CI, SAI, ETA, BSS, or the like, to further determine the physical location of the computing device 500 on the surface of the Earth. In one embodiment, however, the computing device 500 may communicate through other components, provide other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

In the preceding specification, various example embodiments have been described with reference to the accompanying drawings. However, it will be evident that various modifications and changes may be made thereto, and additional embodiments may be implemented without departing from the broader scope of the example embodiments as set forth in the claims that follow. The specification and drawings are accordingly to be regarded in an illustrative rather than restrictive sense.

What is claimed is:

1. A method comprising:
receiving, by a processor, a first set of importance features and a second set of importance features, the first set of importance features associated with a first label and identifying first features used by a machine learning (ML) model to classify data with the first label, and the second set of importance features associated with a second label and identifying second features used by the ML model to classify data with the second label;
generating, by the processor, a first feature dictionary based on the first set of importance features and a second feature dictionary based on the second set of importance features;
identifying, by the processor, a subset of labeled examples in a training dataset used to train the ML model based on the first feature dictionary and second feature dictionary;
modifying, by the processor, the subset of labeled examples based on the first feature dictionary and second feature dictionary, the modifying generating a modified training data set; and
retraining, by the processor, the ML model using the modified training data set.

2. The method of claim 1, wherein each importance filter is associated with a corresponding confidence value and wherein the method further comprises filtering the first set of importance features and the second set of importance features, the filtering comprising removing an importance feature having a confidence value below a pre-configured threshold.

3. The method of claim 1, wherein generating a feature dictionary for a respective label and a respective set of importance features comprises:
identifying a set of unique importance features for the respective label;
calculating a total number of occurrences for each of the unique importance features in the respective set of importance features;
ordering the set of unique importance features by the total number of occurrences to generate an ordered set of unique importance features; and
storing the ordered set of unique importance features as the feature dictionary, the storing comprising associating each unique importance feature with a corresponding total number of occurrences.

4. The method of claim 3, wherein the method further comprises generating a common feature dictionary, the common feature dictionary including a set of importance features present in both the first feature dictionary and the second feature dictionary.

5. The method of claim 4, wherein identifying a subset of labeled examples comprises filtering the labeled examples using the common feature dictionary.

6. The method of claim 1, wherein identifying a subset of labeled examples comprises determining, for a respective labeled example, whether a number of importance features in the respective labeled example appearing in a corresponding feature dictionary exceeds a pre-configured threshold.

7. The method of claim 1, wherein modifying the subset of labeled examples comprises one or more of altering a label of a respective labeled example or removing the respective labeled example from the subset of labeled examples.

8. A non-transitory computer-readable storage medium for tangibly storing computer program instructions capable of being executed by a computer processor, the computer program instructions defining steps of:
receiving a first set of importance features and a second set of importance features, the first set of importance features associated with a first label and identifying first features used by a machine learning (ML) model to classify data with the first label, and the second set of importance features associated with a second label and identifying second features used by the ML model to classify data with the second label;
generating a first feature dictionary based on the first set of importance features and a second feature dictionary based on the second set of importance features;
identifying a subset of labeled examples in a training dataset used to train the ML model based on the first feature dictionary and second feature dictionary;
modifying the subset of labeled examples based on the first feature dictionary and second feature dictionary, the modifying generating a modified training data set; and
retraining the ML model using the modified training data set.

9. The non-transitory computer-readable storage medium of claim 8, wherein each importance filter is associated with a corresponding confidence value and wherein the steps further comprise filtering the first set of importance features and the second set of importance features, the filtering comprising removing an importance feature having a confidence value below a pre-configured threshold.

10. The non-transitory computer-readable storage medium of claim 8, wherein generating a feature dictionary for a respective label and a respective set of importance features comprises:
identifying a set of unique importance features for the respective label;
calculating a total number of occurrences for each of the unique importance features in the respective set of importance features;
ordering the set of unique importance features by the total number of occurrences to generate an ordered set of unique importance features; and
storing the ordered set of unique importance features as the feature dictionary, the storing comprising associating each unique importance feature with a corresponding total number of occurrences.

11. The non-transitory computer-readable storage medium of claim 8, wherein the method further comprises generating a common feature dictionary, the common feature dictionary including a set of importance features present in both the first feature dictionary and the second feature dictionary.

12. The non-transitory computer-readable storage medium of claim 11, wherein identifying a subset of labeled examples comprises filtering the labeled examples using the common feature dictionary.

13. The method of claim 1, wherein identifying a subset of labeled examples comprises determining, for a respective labeled example, whether a number of importance features in the respective labeled example appearing in a corresponding feature dictionary exceeds a pre-configured threshold.

14. The non-transitory computer-readable storage medium of claim 8, wherein modifying the subset of labeled examples comprises one or more of altering a label of a respective labeled example or removing the respective labeled example from the subset of labeled examples.

15. A device comprising:
a processor configured to:
receive a first set of importance features and a second set of importance features, the first set of importance features associated with a first label and identifying first features used by a machine learning (ML) model to classify data with the first label, and the second set of importance features associated with a second label and identifying second features used by the ML model to classify data with the second label,
generate a first feature dictionary based on the first set of importance features and a second feature dictionary based on the second set of importance features;
modify a training data set used to train the ML model based on the first feature dictionary and second feature dictionary, the modifying generating a modified training data set; and
retrain the ML model using the modified training data set.

16. The device of claim 15, wherein generating a feature dictionary for a respective label and a respective set of importance features comprises:
identifying a set of unique importance features for the respective label;
calculating a total number of occurrences for each of the unique importance features in the respective set of importance features;
ordering the set of unique importance features by the total number of occurrences to generate an ordered set of unique importance features; and
storing the ordered set of unique importance features as the feature dictionary, the storing comprising associating each unique importance feature with a corresponding total number of occurrences.

17. The device of claim 16, wherein the method further comprises generating a common feature dictionary, the common feature dictionary including a set of importance features present in both the first feature dictionary and the second feature dictionary.

18. The device of claim 17, wherein identifying a subset of labeled examples comprises filtering the labeled examples using the common feature dictionary.

19. The device of claim 15, wherein identifying a subset of labeled examples comprises determining, for a respective labeled example, whether a number of importance features in the respective labeled example appearing in a corresponding feature dictionary exceeds a pre-configured threshold.

20. The device of claim 15, wherein modifying the subset of labeled examples comprises one or more of altering a label of a respective labeled example or removing the respective labeled example from the subset of labeled examples.
